(19) United States
(12) Patent Application Publication
(10) Pub. No.: US 2008/0113198 A1
(43) Pub. Date: May 15, 2008

(54) LEATHER ARTICLES AND METHODS FOR PRODUCING THE SAME

(76) Inventor: Jusong Xia, Gastonia, NC (US)

Correspondence Address: Legal Department (M-495), P.O. Box 1926, Spartanburg, SC, 29304, US

(21) Appl. No.: 11/558,700

(22) Filed: Nov. 10, 2006

(51) Int. Cl. B32B 27/06; B32B 27/40; B05D 3/02

(52) U.S. Cl. 428/423.4; 428/423.1; 427/389; 427/389.9

(57) ABSTRACT

Novel leather articles comprise a substrate and a coating applied to a surface of the substrate. The coating comprises a prepolymer or resin. The prepolymer or resin can be produced, for example, by the reaction of (i) an isocyanate, (ii) at least one reactant selected from the group consisting of chain extenders, polyols, and combinations thereof, and (iii) an active hydrogen-terminated colorant. The active hydrogen-terminated colorant comprises a chromophore and an active hydrogen-terminated constituent bound to the chromophore. Novel methods for producing leather articles using active hydrogen-terminated colorants are also provided.

### FIELD OF THE INVENTION

The present invention is directed to substrates comprising a coating on the surface thereof, such as substrates having a coating thereon intended to mimic the look and feel of leather. Such substrates include, but are not limited to, natural leather substrates and textile materials.

### BACKGROUND OF THE INVENTION

Synthetic leather typically is produced by coating or laminating an elastic polymer resin, such as a polyurethane resin, a polyvinyl chloride resin, or a blend of such resins, onto the surface of a fibrous base material. In order to produce a synthetic leather in a variety of colors and/or shades, various pigments or dyes have been used to color the resin applied to the surface of the base material. However, the use of such pigments and dyes has not been without its disadvantages and drawbacks.

For example, pigments usually have low tinting strength and a dull shade, which can limit the aesthetic qualities of synthetic leather produced using them. Pigments typically lack solubilizing groups, which frequently allows the pigment particles to aggregate and form larger secondary and tertiary aggregate particles during production processes. Owing to these difficulties, synthetic leathers colored with conventional pigments often exhibit poor color retention, have a dark or dull shade, or contain unsuitable variations in color depth. While these problems can be partially addressed through the addition of dispersing agents or by utilizing pigment dispersions, these measures often result in increased production costs and still require great care to minimize color variations produced by settling of the pigment(s) and/or incompatibility of these components with the resin.

Dyes, on the other hand, typically contain solubilizing groups that can facilitate dispersion of the dye in a suitable medium. Dyes also typically exhibit relatively high tinting strength, good transparency, good thermal stability, and acceptable resin compatibility. Nevertheless, dyes typically exhibit poor weather durability, poor water resistance, poor oil resistance, and often migrate or bleed through to the transfer substrates, such as a release paper, used to produce the synthetic leather and to other substrates that the dyes may contact, such as a polyvinyl chloride (PVC) substrate. In order to address the migration of dyes to the transfer substrate, attempts have been made to utilize nylon or polyurethane overcoats applied to the transfer substrate. However, satisfactory topcoats have not been developed without incurring significantly higher cost.

A need therefore remains for novel colored leather articles that address the deficiencies of articles produced with conventional pigments and dyes, while still exhibiting the desired aesthetic qualities. The present invention provides such articles and methods for producing the same.

### BRIEF SUMMARY OF THE INVENTION

In one embodiment, a leather article comprises a substrate and a coating on at least one surface of the substrate. The coating comprises a prepolymer or resin. The prepolymer or resin can be produced, for example, by the reaction of (i) an isocyanate, (ii) at least one reactant selected from the group consisting of chain extenders, polyols, and combinations thereof, and (iii) an active hydrogen-terminated colorant. The active hydrogen-terminated colorant comprises a chromophore and at least one active hydrogen-terminated constituent bound to the chromophore.

In a first embodiment, a method for producing a leather article comprises the steps of (a) providing a prepolymer or resin produced by the reaction of (i) an isocyanate, (ii) at least one reactant selected from the group consisting of chain extenders, polyols, and combinations thereof, and (iii) an active hydrogen-terminated colorant, (b) applying the prepolymer or resin onto a transfer substrate to form a film coating of the prepolymer, (c) applying a backing substrate onto the film coating of the prepolymer or resin produced in step (b), (d) heating the assembled backing substrate, film coating, and transfer substrate to bond the backing substrate to the film coating of the prepolymer or resin, and (e) removing the transfer substrate to yield a leather article comprising the backing substrate and a coating on a surface thereof. The coating comprises a prepolymer or resin produced by the reaction of (i) the isocyanate, (ii) the at least one reactant selected from the group consisting of chain extenders, polyols, and combinations thereof, and (iii) the active hydrogen-terminated colorant. The active hydrogen-terminated colorant is selected from the group of colorants conforming to structure (I)

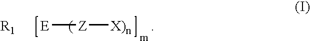

In structure (I), R₁ or R₁-[E]ₘ is an organic chromophore, E is a linking moiety selected from the group consisting of nitrogen, oxygen, sulfur, a sulfite group, a sulfonamide group, and a carboxyl group, and n and m are independently selected from the group consisting of integers between 1 and 5. Each Z is a divalent organic moiety independently selected from the group consisting of C₁-C₂₀ alkyl moieties, aryl moieties, and alkoxyl moieties. Each X is an end group independently selected from the group consisting of hydrogen, a hydroxyl group, a sulfhydryl group, thiol groups, amine groups, alkyl groups, aryl groups, alkyl ester groups, aryl ester groups, organic sulfonate groups, organic sulfate groups, and amide groups. At least one -Z-X constituent terminates in an group selected from the group consisting of a hydroxyl group, thiol groups, primary amine groups, secondary amine groups, primary amide groups, and secondary amide groups.

In a second embodiment, a method for producing a leather article comprises the steps of (a) providing a prepolymer or resin produced by the reaction of (i) an isocyanate, (ii) at least one reactant selected from the group consisting of chain extenders, polyols, and combinations thereof, and (iii) an active hydrogen-terminated colorant, (b) providing a backing substrate, (c) applying the prepolymer or resin onto a surface of the backing substrate, (d) heating the coated backing substrate produced in step (c) to produce a coating on the surface of the backing substrate, thereby yielding a leather article comprising the backing substrate and a coating on a surface thereof. The coating comprising a prepolymer or resin produced by the reaction of (i) the isocyanate, (ii) the at least one reactant selected from the group consisting of chain extenders, polyols, and combinations thereof, and (iii) the active hydrogen-terminated colorant. The active hydrogen-terminated is selected from the group of colorants conforming to structure (I)

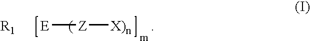

In structure (I), R₁ or R₁-[E]ₘ is an organic chromophore, E is a linking moiety selected from the group consisting of nitrogen, oxygen, sulfur, a sulfite group, a sulfonamide group, and a carboxyl group, and n and m are independently selected from the group consisting of integers between 1 and 5. Each Z is a divalent organic moiety independently selected from the group consisting of C₁-C₂₀ alkyl moieties, aryl moieties, and alkoxyl moieties. Each X is an end group independently selected from the group consisting of hydrogen, a hydroxyl group, a sulfhydryl group, thiol groups, amine groups, alkyl groups, aryl groups, alkyl ester groups, aryl ester groups, organic sulfonate groups, organic sulfate groups, and amide groups. At least one -Z-X constituent terminates in an group selected from the group consisting of a hydroxyl group, thiol groups, primary amine groups, secondary amine groups, primary amide groups, and secondary amide groups.

### DETAILED DESCRIPTION OF THE INVENTION

In one embodiment, a leather article comprises a substrate and a coating on at least one surface of the substrate. The coating comprises a prepolymer or resin. The prepolymer or resin can be produced, for example, by the reaction of (i) an isocyanate, (ii) at least one reactant selected from the group consisting of chain extenders, polyols, and combinations thereof, and (iii) an active hydrogen-terminated colorant.

The substrate can be any suitable substrate, such as a fibrous substrate or a natural leather substrate. In certain possibly preferred embodiments, the substrate is a textile material. Suitable textiles include, but are not limited to, woven textiles, knit textiles, and non-wovens. The textiles can be made from any suitable natural fibers, synthetic fibers, or combinations thereof. In certain possibly preferred embodiments, the textile material can be a non-woven textile material comprising a plurality of synthetic, microdenier fibers (e.g., polyester fibers). In such an embodiment, the coating typically is disposed around a portion of the individual fibers in the non-woven material.

In order to promote adhesion between the substrate and the coating, the substrate can comprise a precoat layer on the surface to which the coating is applied. The precoat layer can comprise any suitable material, such as a material that promotes adhesion between the substrate and the coating. For example, the precoat layer can comprise elastomeric polymers.

The prepolymer or resin in the coating can be any suitable resin. The prepolymer or resin typically will be selected to provide an article that is flexible and durable, while providing the properties necessary or desirable for mimicking real leather. In certain possibly preferred embodiments, the prepolymer or resin is selected from the group consisting of polyurethane resins, polyurea resins, and combinations thereof. Such prepolymers or resins can be produced, for example, by the reaction of (i) an isocyanate, (ii) at least one reactant selected from the group consisting of chain extenders, polyols, and combinations thereof. Suitable polyurethanes include linear polyurethanes as well as cross-linked polyurethanes, such as a polyurethane cross-linked with hexamethylene diisocyanate trimer.

The prepolymers or resins suitable for use in the coating can be produced using any suitable polyol. Suitable polyols include, but are not limited to, glycols of low molecular weight, such as ethylene glycol, 1,2-propylene glycol, 1,3-propylene glycol, 1,4-butylene glycol, and 1,6-hexamethylene glycol; polyester diols obtained from dibasic acids, such as adipic acid, maleic acid, and terephthalic acid; polyester diols, such as polylactones obtained by subjecting lactones to ring-opening polymerization with glycols; polycarbonate diols; and polyether diols, such as polytetramethylene glycol, polyethylene glycol, and polypropylene glycol.

The prepolymers or resins suitable for use in the coating can be produced using any suitable isocyanate. Suitable isocyanates include, but are not limited to, aromatic diisocyanates, such as toluene-2,4-diisocyanate (TDI), 4-methoxy-1,3-phenylene diisocyanate, 4-isopropyl-1,3-phenylene diisocyanate, 4-chloro-1,3-phenylene diisocyanate, 4-butoxy-1,3-phenylene diisocyanate, 2,4-diisocyanatodiphenyl ether, 4,4′-methylenebis(phenyl-isocyanate) (MDI), polymeric MDI, durylene diisocyanate, tolidine diisocyanate, xylylene diisocyanate (XDI), 1,5-naphthalene diisocyanate, benzidine diisocyanate, o-nitrobenzidine diisocyanate, and 4,4-diisocyanatodibenzyl; aliphatic diisocyanates, such as methylene diisocyanate, 1,4-tetramethylene diisocyanate, 1,6-hexamethylene diisocyanate, and 1,10-decamethylene diisocyanate; alicyclic diisocyanates, such as 1,4-cyclohexylene diisocyanate, 4,4-methylene-bis(cyclohexylisocyanate), 1,5-tetrahydronaphthalene diisocyanate, isophorone diisocyanate, hydrogenated MDI, and hydrogenated XDI; and polyurethane prepolymers obtained by reacting any of the aforementioned diisocyanates with polyols or polyamines of low molecular weights such that the resulting prepolymers have isocyanate groups at ends thereof. Among the aforementioned, aromatic diisocyanates, particularly diphenylmethane-4,4′-diisocyante (4,4′-MDI) or polymeric MDI, are preferred for obtaining articles exhibiting good physical characteristics such as thermal stability, solution stability, and fracture strength. Alicyclic diisocyanates, such as isophorones, are preferred for obtaining polyurethanes that exhibit anti-yellowing properties and are not easily discolored upon exposure to sunlight.

The prepolymers or resins suitable for use in the coating can be produced using suitable chain extenders. These include, but are not limited to, water; low-molecular diols, such as ethylene glycol and propylene glycol; aliphatic diamines, such as ethylenediamine; aromatic diamines, such as 4,4′-diaminodiphenylmethane; alicyclic diamines, such as 4,4′-diaminodicyclohexylmethane and isophoronediamine; alkanolamines, such as ethanolamine; hydrazines; and dihydrazides, such as succinic dihydrazide. Among the aforementioned chain extenders, the diamine compounds are preferable, with 4,4′-diaminodiphenylmethane being particularly preferred due to its heat resistance and 4,4′-diaminodicyclohexylmethane being preferred for light resistance. The aforementioned chain extenders can, of course, be used alone or in any suitable combination.

Other resins or polymers can be used in combinations with the aforementioned prepolymers and resins. Thus, in certain embodiments, the coating can comprise one or more polymers or resins selected from the group consisting of polyvinyl chloride (PVC), polyvinylidene chloride, polyvinyl acetate, polyacrylic acid, alkylpolyacrylate, polymethacrylic acid, alkylpolymethacrylate, and copolymers thereof.

The colorant in the coating can be any suitable active hydrogen-terminated colorant. As utilized herein, the term “active hydrogen-terminated colorant” is used to refer to a colorant comprising a chromophore and an active hydrogen-terminated constituent bound to the chromophore. The active hydrogen-terminated constituent can be bound to the chromophore via any suitable means, such as a covalent bond, an ionic bond, or suitable electrostatic interaction. The term “active hydrogen” is utilized herein to refer to a hydrogen atom that is bonded to an atom that is more electronegative than carbon. Suitable active hydrogen-containing groups include, but are not limited to, a hydroxyl group, amine groups, amide groups, and sulfhydryl groups (e.g., thiols)

Suitable active hydrogen-terminated colorants include, but are not limited to, those active hydrogen-terminated colorants conforming to structure (I) below

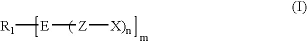

In structure (I), R₁ or R₁-[E]ₘ represents an organic chromophore. E is a linking moiety selected from the group consisting of nitrogen, oxygen, sulfur, a sulfite group, a sulfonamide group, and a carboxyl group. Also, n and m are independently selected from the group consisting of integers between 1 and 5. X is an end group independently selected from the group consisting of hydrogen, a hydroxyl group, a sulfhydryl group, thiol groups, amine groups, alkyl groups, aryl groups, alkyl ester groups, aryl ester groups, organic sulfonate groups, organic sulfate groups, and amide groups. Each Z in the structure is a divalent organic moiety selected from the group consisting of C₁-C₂₀ alkyl moieties (e.g., C₂-C₁₀ alkyl moieties), aryl moieties, or alkoxyl moieties. In structure (I), at least one -Z-X constituent terminates in a group selected from the group consisting of a hydroxyl group, thiol groups, primary amine groups, secondary amine groups, primary amide groups, and secondary amide groups.

An example of suitable active hydrogen-terminated colorants conforming to structure (I) include methine-based colorants, such as those colorants conforming to structure (IV)

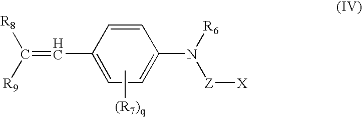

In structure (IV), R₆ is selected from the group consisting of hydrogen, alkyl groups, aryl groups, arylalkyl groups, alkylaryl groups, and constituents having the structure -Z-X, as defined above. Each R₇ is independently selected from the group consisting of hydrogen, halogen atoms, alkyl groups, alkoxy groups, nitrile groups, nitro groups, amide groups, and sulfonamide groups, and q is an integer between 0 and 4. R₈ and R₉ are independently selected from the group consisting of hydrogen, halogen atoms, tertiary amino groups, imine groups, cyano groups, pyridinium groups, ester groups, amide groups, sulfate groups, sulfonate groups, sulfide groups, sulfoxide groups, phosphine groups, phosphinium groups, phosphate groups, nitrile groups, mercapto groups, nitro groups, sulfone groups, acyl groups, azo groups, alkyl groups, alkoxy groups, aryl groups, aryloxy groups, arylalkyl groups, arylalkoxy groups, alkylaryl groups, and alkylaryloxy groups. The -Z-X constituent (or at least one of the -Z-X constituents if more than one are present) terminates in a group selected from the group consisting of a hydroxyl group, thiol groups, primary amine groups, secondary amine groups, primary amide groups, and secondary amide groups.

More specific examples of methine-based active hydrogen-terminated colorants suitable for use in the leather articles include those active hydrogen-terminated colorants conforming to structure (IX)

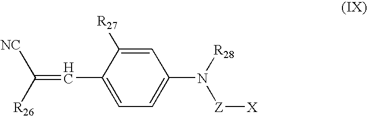

In structure (IX), R₂₆ is selected from the group consisting of cyano groups, nitro groups, alkylcarbonyl groups, arylalkylcarbonyl groups, alkoxycarbonyl groups, arylalkoxycarbonyl groups, amide groups, and alkylamide groups. R₂₇ is selected from the group consisting of hydrogen, C₁-C₂₀ alkyl groups, and C₇-C₂₀ arylalkyl groups. R₂₈ is selected from the group consisting of hydrogen, C₁-C₂₀ alkyl groups, aryl groups, C₇-C₂₀ arylalkyl groups, C₇-C₂₀ alkylaryl groups, and constituents having the structure -Z-X, as defined above. The -Z-X constituent (or at least one -Z-X constituents if more than one are present) terminates in a group selected from the group consisting of a hydroxyl group, thiol groups, primary amine groups, secondary amine groups, primary amide groups, and secondary amide groups. In certain possibly preferred embodiments of the methine-based colorants conforming to structure (IX), R₂₆ is a cyano group or a C₁-C₁₀ alkylcarbonyl group, R₂₇ is hydrogen or a methyl group, R₂₈ is an active hydrogen-terminated constituent having the structure -Z-X, and Z is a divalent organic moiety selected from the group consisting of C₂-C₁₀ alkyl moieties. In certain possibly preferred embodiments, the methine-based colorant conforms to structure (XVII) below

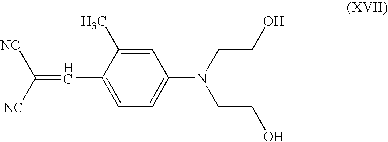

Another example of suitable active hydrogen-terminated colorants conforming to structure (I) include azo-based colorants, such as those colorants conforming to structure (V)

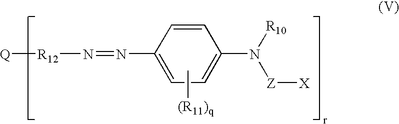

In structure (V), R₁₀ is selected from the group consisting of hydrogen, alkyl groups, aryl groups, arylalkyl groups, alkylaryl groups, and active hydrogen-terminated constituents having the structure -Z-X. Each R₁₁ is independently selected from the group consisting of hydrogen, halogen atoms, alkyl groups, alkoxy groups, nitrile groups, nitro groups, amide groups, and sulfonamide groups, and q is an integer between 0 and 4. R₁₂ is selected from the group consisting of aromatic groups and heteroatom-containing aromatic groups. Q is hydrogen or a linking group selected from the group consisting of oxygen, sulfur, a carbonyl group, a sulfonyl group, substituted and unsubstituted 1,3-benzothiazole groups, C₁-C₈ alkyl groups, C₂-C₈ alkene groups, a p-phenylenediamine group, a m-hydroxybenzene group, and a m-di(C₁-C₄) alkoxybenzene group, and r is equal to 1 or 2. The -Z-X constituent (or at least one of the -Z-X constituents if more than one are present) terminates in a group selected from the group consisting of a hydroxyl group, thiol groups, primary amine groups, secondary amine groups, primary amide groups, and secondary amide groups.

More specific examples of azo-based, active hydrogen-terminated colorants suitable for use in the leather articles include those active hydrogen-terminated colorants conforming to structure (X)

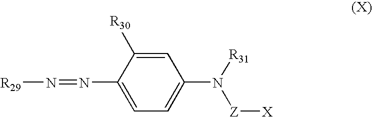

In structure (X), R₂₉ is selected from the group consisting of aromatic groups, heteroatom-containing aromatic groups, substituted and unsubstituted 1,3-benzothiazole groups, and substituted and unsubstituted 1,2-benzisothiazole groups (e.g., substituted and unsubstituted 1,2-benzisothiazole groups attached to the azo group through the 3-position of the benzisothiazole group). R₃₀ is selected from the group consisting of hydrogen, C₁-C₂₀ alkyl groups, and C₇-C₂₀ arylalkyl groups. R₃₁ is selected from the group consisting of hydrogen, C₁-C₂₀ alkyl groups, aryl groups, C₇-C₂₀ arylalkyl groups, C₇-C₂₀ alkylaryl groups, and active hydrogen-terminated constituents having the structure -Z-X. The -Z-X constituent (or at least one of the -Z-X constituents if more than one are present) terminates in a group selected from the group consisting of a hydroxyl group, thiol groups, primary amine groups, secondary amine groups, primary amide groups, and secondary amide groups. In certain possibly preferred embodiments of the azo-based colorants conforming to structure (X), R₂₉ is an aromatic group or a heteroatom-containing aromatic group, R₃₀ is a hydrogen or a methyl group, R₃₁ is an active hydrogen-terminated constituent having the structure -Z-X, and Z is a divalent organic moiety selected from the group consisting of C₂-C₁₀ alkyl moieties. In certain possibly preferred embodiments, the azo-based, active hydrogen-terminated colorant conforms to structure (XVIII) below

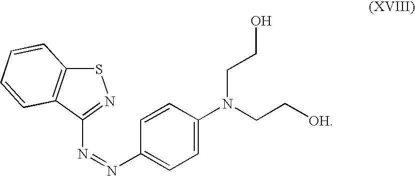

Azo-based colorants suitable for use in the leather articles include bisazo-based colorants such as those conforming to structure (XI)

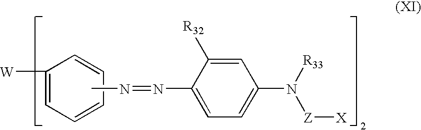

In structure (XI), W is a linking group and is selected from the group consisting of oxygen, sulfur, a sulfone group, a carbonyl group, C₁-C₈ alkyl groups, C₂-C₈ alkylene groups, and p-phenylenediamine. R₃₂ is selected from the group consisting of hydrogen, C₁-C₂₀ alkyl groups, and C₇-C₂₀ arylalkyl groups. R₃₃ is selected from the group consisting of hydrogen, C₁-C₂₀ alkyl groups, aryl groups, C₇-C₂₀ arylalkyl groups, C₇-C₂₀ alkylaryl groups, and active hydrogen-terminated constituents having the structure -Z-X. The -Z-X constituent (or at least one of the -Z-X constituents if more than one are present) terminates in a group selected from the group consisting of a hydroxyl group, thiol groups, primary amine groups, secondary amine groups, primary amide groups, and secondary amide groups. In certain possibly preferred embodiments of the bisazo-based colorants conforming to structure (XI), W is a sulfone group, R₃₂ is hydrogen or a methyl group, R₃₃ is an active hydrogen-terminated constituent having the structure -Z-X, and Z is a divalent organic moiety selected from the group consisting of C₂-C₁₀ alkyl moieties. In certain possibly preferred embodiments, the bisazo-based, active hydrogen-terminated colorant conforms to structure (XIX)

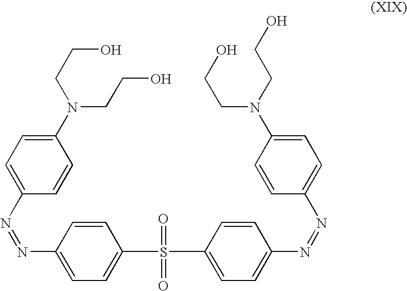

Suitable active hydrogen-terminated colorants conforming to structure (I) also include triphenylmethane-based colorants, such as those colorants conforming to structure (VI)

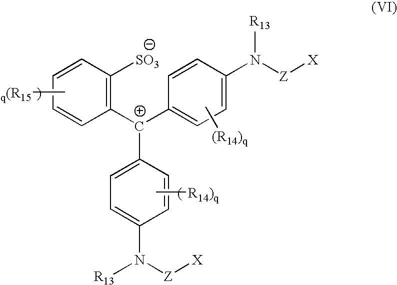

R₁₃ is selected from the group consisting of hydrogen, alkyl groups, aryl groups, arylalkyl groups, alkylaryl groups, and active hydrogen-terminated constituents having the structure -Z-X, as defined above. R₁₄ is selected from the group consisting of hydrogen, halogen atoms, alkyl groups, alkoxy groups, alkylamino groups, and arylamino groups. R₁₅ is selected from the group consisting of hydrogen, halogen atoms, alkyl groups, alkoxy groups, alkylamino groups, arylamino groups, cyano groups, nitro groups, amide groups, sulfite groups, and sulfonamide groups, and each q is an integer between 0 and 4. The -Z-X constituent (or at least one of the -Z-X constituents if more than one are present) terminates in a group selected from the group consisting of a hydroxyl group, thiol groups, primary amine groups, secondary amine groups, primary amide groups, and secondary amide groups.

More specific examples of triphenylmethane-based, active hydrogen-terminated colorants suitable for use in the leather articles include those active hydrogen-terminated colorants conforming to structure (XII)

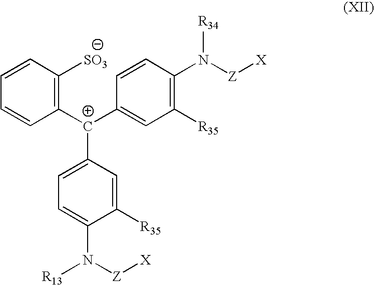

In structure (XII), R₃₅ is selected from the group consisting of hydrogen, halogen atoms, alkyl groups, alkoxy groups, alkylamino groups, and arylamino groups. R₃₄ is selected from the group consisting of hydrogen, alkyl groups, aryl groups, arylalkyl groups, alkylaryl groups, and active hydrogen-terminated constituents having the structure -Z-X. Alternatively, R₃₅ can be joined to R₃₄ to form a ring. In certain possibly preferred embodiments of the triphenylmethane-based colorants conforming to structure (XII), R₃₅ is hydrogen, R₃₄ is an active hydrogen-terminated constituent having the structure -Z-X, and Z is a divalent organic moiety selected from the group consisting of C₂-C₁₀ alkyl moieties. In certain possibly preferred embodiments, the triphenylmethane-based, active hydrogen-terminated colorant conforms to structure (XX) below

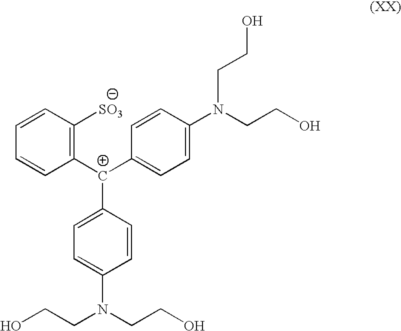

Suitable active hydrogen-terminated colorants conforming to structure (I) further include benzodifuranone-based colorants, such as those colorants conforming to structure (VII)

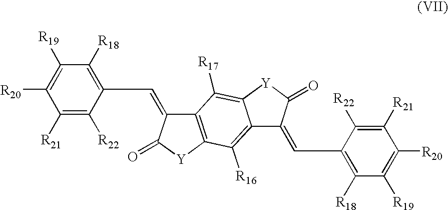

In structure (VII), Y is selected from the group consisting of oxygen, sulfur, and groups having the structure —NR₄₀, where R₄₀ is selected from the group consisting of hydrogen, alkyl groups, and aryl groups. R₁₆ and R₁₇ are independently selected from the group consisting of hydrogen, halogen atoms, a hydroxyl group, alkyl groups, alkenyl groups, and alkoxy groups. R₁₈, R₁₉, R₂₀, R₂₁, and R₂₂ are independently selected from the group consisting of hydrogen, halogen atoms, C₁-C₂₀ alkyl groups, C₁-C₂₀ alkylester groups, a hydroxyl group, thio groups, cyano groups, sulfonyl groups, sulfo groups, sulfato groups, aryl groups, nitro groups, carboxyl groups, C₁-C₂₀ alkoxy groups, C₁-C₂₀ alkylamino groups, acrylamino groups, C₁-C₂₀ alkylthio groups, C₁-C₂₀ alkylsulfonyl groups, C₁-C₂₀ alkylphenyl groups, phosphonyl groups, C₁-C₂₀ alkylphosphonyl groups, C₁-C₂₀ alkoxycarbonyl groups, phenylthio groups, and active hydrogen-terminated constituents having the structure -E-(Z-X)ₙ, as defined above. At least one of R₁₈, R₁₉, R₂₀, R₂₁, and R₂₂ is an active hydrogen-terminated constituent having the structure -E-(Z-X)ₙ, and the -Z-X constituent (or at least one of the -Z-X constituents if more than one are present) terminates in a group selected from the group consisting of a hydroxyl group, thiol groups, primary amine groups, secondary amine groups, primary amide groups, and secondary amide groups.

More specific examples of benzodifuranone-based active hydrogen-terminated colorants suitable for use in the leather articles include those active hydrogen-terminated colorants conforming to structure (XII)

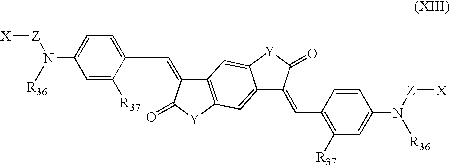

In structure (XIII), R₃₆ is selected from the group consisting of hydrogen, alkyl groups, aryl groups, arylalkyl groups, alkylaryl groups, and active hydrogen-terminated constituents having the structure -Z-X. R₃₇ is selected from the group consisting of hydrogen, halogen atoms, alkoxy groups, alkylamino groups, and a groups having the structure R₄₁—C(O)—NH—, where R₄₁ is selected from the group consisting of hydrogen, alkyl groups, and aryl groups. The -Z-X constituent (or at least one of the -Z-X constituents if more than one are present) terminates in a group selected from the group consisting of a hydroxyl group, thiol groups, primary amine groups, secondary amine groups, primary amide groups, and secondary amide groups. In certain possibly preferred embodiments of the benzodifuranone-based colorants conforming to structure (XIII), R₃₇ is hydrogen or a methyl group, R₃₆ is an active hydrogen-terminated constituent having the structure -Z-X, and Z is a divalent organic moiety selected from the group consisting of C₂-C₁₀ alkyl moieties. In certain possibly preferred embodiments, the benzodifuranone-based, active hydrogen-terminated colorant conforms to structure (XXI) below

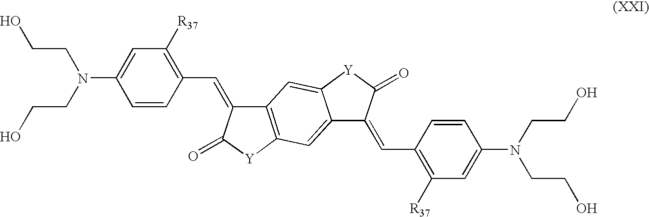

In structure (XXI), Y is selected from the group consisting of oxygen, sulfur, and groups having the structure —NR₄₀, where R₄₀ is selected from the group consisting of hydrogen, alkyl groups, and aryl groups. R₃₇ is hydrogen or a methyl group.

Another example of suitable active hydrogen-terminated colorants conforming to structure (I) include anthraquinone-based colorants, such as those colorants conforming to structure (VIII)

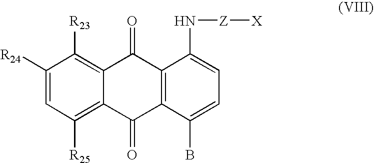

In structure (VIII), R₂₃ is selected from the group consisting of hydrogen, halogen atoms, a hydroxyl group, amine groups, nitro groups, and acetamide groups. R₂₄ and R₂₅ are independently selected from the group consisting of hydrogen and a hydroxyl group, and the -Z-X constituent (or at least one of the -Z-X constituents if more than one are present) terminates in a group selected from the group consisting of a hydroxyl group, thiol groups, primary amine groups, secondary amine groups, primary amide groups, and secondary amide groups. B is selected from the group consisting of groups conforming to structure (XV) and structure (XVI)

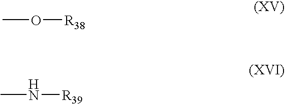

In structure (XV), R₃₈ is selected from the group consisting of hydrogen, C₁-C₁₈ alkyl groups, and aryl groups. In structure (XVI), R₃₉ is selected from the group consisting of aryl groups and active hydrogen-terminated constituents having the structure -Z-X, as defined above.

More specific examples of anthraquinone-based, active hydrogen-terminated colorants suitable for use in the leather articles include those active hydrogen-terminated colorants conforming to structure (XIV)

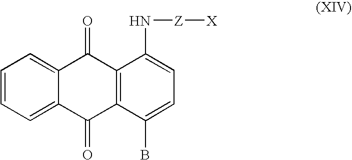

### In structure (XIV), B is selected from the group consisting of groups conforming to structure (XV) and structure (XVI)

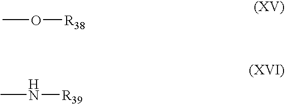

In structure (XV), R₃₈ is selected from the group consisting of hydrogen, C₁-C₁₈ alkyl groups, and aryl groups. In structure (XVI), R₃₉ is selected from the group consisting of aryl groups and active hydrogen-terminated constituents having the structure -Z-X. The -Z-X constituent in structure (XIV) (or at least one of the -Z-X constituents if more than one are present) terminates in a group selected from the group consisting of a hydroxyl group, thiol groups, primary amine groups, secondary amine groups, primary amide groups, and secondary amide groups. In certain possibly preferred colorants conforming to structure (XIV), A is selected from the group consisting of alkyl groups and aryl groups, B is a group having the structure —NH—R₃₉, and Z is a divalent organic moiety selected from the group consisting of C₂-C₁₀ alkyl moieties. In certain possibly preferred embodiments, the anthraquinone-based colorant conforms to structure (XXII) below

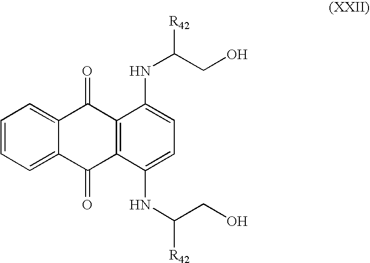

wherein R₄₂ is selected from the group consisting of hydrogen, methyl groups, and ethyl groups.

The selection of a suitable active hydrogen-terminated colorant can be based on several factors. For example, when the active hydrogen-terminated colorant is used to produce a colored polyurethane prepolymer or resin, the terminal active hydrogen on the colorant allows it to react with a suitable isocyanate-containing compound, thereby producing a colored prepolymer or resin. This colored prepolymer or resin can then be further reacted to produce a colored leather article according to the invention.

The active hydrogen-terminated colorants can be present in the leather articles of the invention in any suitable amount. Generally, the amount of the active hydrogen-terminated colorants employed in a colored polyurethane prepolymer or resin or leather article depends upon the desired shade and depth of color. Other factors may include whether or not other coloring agents are employed, such as dyes and/or pigments. When used to produce polyurethane prepolymers or resins, the molar ratio of isocyanate/OH from the active hydrogen-terminated colorant(s) needs to be taken into account to adjust the loading of polyols since some active hydrogen-terminated colorants contain hydroxyl group(s). Another factor to consider is whether the active hydrogen-terminated colorants are used in the base layers or the skin coat layer. The amount of the active hydrogen-terminated colorant(s) employed is not limited to a specific weight range. However, to produce a colored polyurethane prepolymer or resin, the active hydrogen-terminated colorant(s) can be used in an amount of about 0.01 to 60% by weight, and may also be in the range of about 0.1 to about 15% by weight, with respect to the requirement of targeted color shade or depth or physical properties of the prepolymer or resin to be made. In certain possibly preferred embodiments, the amount of active hydrogen-terminated colorant(s) used to produce the prepolymer or resin can be an amount sufficient to provide a molar equivalent of active-hydrogen (from the colorant) that is equal to or less than that of isocyanate used to produce the prepolymer or resin in the coating.

In order to facilitate the incorporation of the colorants with an isocyanate and chain extender and/or polyol to produce a colored prepolymer or resin, the active hydrogen-terminated colorants typically are provided in a liquid form. For those active hydrogen-terminated colorants that are solid at typical processing conditions, the colorant can be provided as a solution or dispersion of the colorant in a suitable solvent, such as dimethylformamide, toluene, isopropyl alcohol, and mixtures thereof (e.g., a mixture of toluene and isopropyl alcohol).

Colored leather articles containing active hydrogen-terminated colorants generally exhibit low to no bleeding and migration, for example, to the release paper. While not wishing to be bound to any particular theory, this is believed to be due to the incorporation of the active hydrogen-terminated colorant(s) into the polymer chain of the prepolymer or resin.

In addition to the above-described active hydrogen-terminated colorants, other coloring agents can be incorporated into the leather article in order to control the color hue. These coloring agents include conventionally known pigments and dyes. Examples of blue pigments include, but are not limited to, phthalocyanine C.I. Pigment Blue 15:3 and indanthrone C.I. Pigment Blue 60; examples of red pigments include, but are not limited to, quinacridone C.I. Pigment Red 122, azo C.I. Pigment Red 22, C.I. Pigment Red 48:1, C.I. Pigment Red 48:3 and C.I. Pigment Red 57:1; examples of yellow pigments include, but are not limited to, azo C.I. Pigment Yellow 12, C.I. Pigment Yellow 13, C.I. Pigment Yellow 14, C.I. Pigment Yellow 17, C.I. Pigment Yellow 97, C.I. Pigment Yellow 155, benzimidazolone C.I. Pigment Yellow 151, C.I. Pigment Yellow 154 and C.I. Pigment Yellow 180; examples of black pigments include, but are not limited to, carbon black. Examples of suitable dyes include, but are not limited to, solvent dyes, such as Yellow 82, Orange 5, Orange 62, Red 8, Red 62, Red 122, Blue 70, Black 27, and Black 34. For ease of handling and mixing in the production of the leather articles, any pigments used preferably are added in the form of a dispersion or in resin pallet/flake forms, and any dyes used preferably are added in the form of a solution or in resin pallet/flake forms.

The leather articles of the invention can be produced using any suitable method. For example, the leather articles can be produced using both “a direct coating process” and “a transfer coating process.” In two-component technologies, active hydrogen-terminated colorants preferably are mixed with chain extenders and/or polyols and reacted with isocyanates to form a high viscosity isocyanate-terminated or active hydrogen-terminated prepolymer. This prepolymer can then be directly coated onto a substrate or onto a transfer substrate (e.g., release paper) using a doctor blade and cured by respective curing methods. If a free resin film is produced, the film then needs to be laminated to a substrate (e.g., a textile substrate) in a subsequent step.

In a first method embodiment, a method for producing a leather article comprises the steps of (a) providing a prepolymer or resin produced by the reaction of (i) an isocyanate, (ii) at least one reactant selected from the group consisting of chain extenders, polyols, and combinations thereof, and (iii) an active hydrogen-terminated colorant, (b) applying the prepolymer or resin onto a transfer substrate to form a film coating of the prepolymer, (c) applying a backing substrate onto the film coating of the prepolymer or resin produced in step (b), (d) heating the assembled backing substrate, film coating, and transfer substrate to bond the backing substrate to the film coating of the prepolymer or resin, and (e) removing the transfer substrate to yield a leather article comprising the backing substrate and a coating on a surface thereof. The coating comprises a prepolymer or resin produced by the reaction of (i) the isocyanate, (ii) the at least one reactant selected from the group consisting of chain extenders, polyols, and combinations thereof, and (iii) the active hydrogen-terminated colorant.

In a second embodiment, a method for producing a leather article comprises the steps of (a) providing a prepolymer or resin produced by the reaction of (i) an isocyanate, (ii) at least one reactant selected from the group consisting of chain extenders, polyols, and combinations thereof, and (iii) an active hydrogen-terminated colorant, (b) providing a backing substrate, (c) applying the prepolymer or resin onto a surface of the backing substrate, (d) heating the coated backing substrate produced in step (c) to produce a coating on the surface of the backing substrate, thereby yielding a leather article comprising the backing substrate and a coating on a surface thereof. The coating comprising a prepolymer or resin produced by the reaction of (i) the isocyanate, (ii) the at least one reactant selected from the group consisting of chain extenders, polyols, and combinations thereof, and (iii) the active hydrogen-terminated colorant. In such an embodiment, the prepolymer or resin can be applied to the substrate using any suitable means, such as dip coating, spray coating, and the like.

The active hydrogen-terminated colorant, isocyanate, chain extender, polyol (if present), and substrate utilized in the method embodiments can be any suitable active hydrogen-terminated colorant, isocyanate, chain extender, polyol, and substrate, including those described above with respect to the leather articles according to the invention. The transfer substrate used in the methods can be any substrate that permits the formation of a resin coating thereon, while still enabling that resin coating to be released from the substrate without damaging the coating. Suitable transfer substrates include, but are not limited to, a release paper, such as a silicone-treated, mirror-surface release paper.

In accordance with the method embodiments, a leather article can be produce, for example, by thoroughly mixing an active hydrogen-terminated colorant, one or more suitable chain extenders, one or more suitable isocyanates, and a polyol (if desired) in a suitable medium, such as dimethylformamide or a combination of methyl ethyl ketone and dimethylformamide. The mixture is then reacted to form an isocyanate-terminated or active hydrogen-terminated prepolymer or a resin, which resin or prepolymer has the active hydrogen-terminated colorant incorporated into the polymeric chain of the resin or prepolymer. As will be understood by those of ordinary skill in the art, the active hydrogen-terminated colorant is incorporated into the polymeric chain through the reaction of at least a portion of the active hydrogen-terminated constituents of the colorant with the isocyanate. The isocyanate can also react with the chain extender(s) and/or polyol(s), which results in “linking” of the active hydrogen-terminated colorant and chain extender(s) and/or polyol(s) through a urethane group and the formation of the polymeric chain of the prepolymer or resin. The resulting prepolymer or resin typically is in the form of a viscous solution or dispersion, which can be further diluted with a suitable medium (e.g., dimethylformamide or a combination of methyl ethyl ketone and dimethylformamide) to facilitate application of the prepolymer or resin to the transfer substrate. Once applied to the transfer substrate, the solvent/medium is then removed by oven drying or other drying process to produce a prepolymer or resin coating on the transfer substrate. The prepolymer or resin produced by the above-described reaction can, in certain possibly preferred embodiments, be used in combination with other commercially-available resins to produce the coating on the surface of the substrate. Suitable resins include, but are not limited to, those commercially-available polyurethane resins, polyurea resins, acrylic resins, urethane-acrylic hybrid resins, and polyvinyl chloride resins currently used in the manufacture of leather articles (e.g., synthetic leather articles).

The following examples further illustrate the invention but, of course, should not be construed as in any way limiting its scope.

### EXAMPLE 1

This example demonstrates the production of a polyurethane prepolymer using an active hydrogen-terminated colorant. 5.25 parts of Fomrez® polyester polyol (available from Witco) having a molecular weight of 500 and an OH number of 225, 1.49 parts of a yellow dye conforming to structure (XVII), 7.5 parts of 1,4-butyleneglycol, and 34 parts of dimethylformamide (DMF) were charged into a 3-neck flask equipped with a reflux condenser, a mechanical stirrer, and a thermo-controller. With vigorous stirring, 28.3 parts of diphenylmethane-4,4′-diisocyanate were slowly added at a temperature of about 55° C. After stirring for 30 minutes, 34 parts of DMF were again added, and the whole mixture was then heated to approximately 65-70° C. for approximately 2 hours to complete the reaction. The resulting product was then adjusted with DMF to yield a yellow viscous polyurethane solution having approximately 38% solids content by weight.

### EXAMPLE 2

This example demonstrates the production of a polyurethane prepolymer using an active hydrogen-terminated colorant. 17.4 parts of Fomrez® polyester polyol (available from Witco) having a molecular weight of 500 and an OH number of 225 and 8.2 parts of a blue dye conforming to structure (XXII) (in which R₄₂ was hydrogen) were dissolved in 125 parts of dimethylformamide (DMF) in a 3-neck flask equipped with a reflux condenser, a mechanical stirrer, and a thermo-controller. With vigorous stirring, 35.2 parts of diphenylmethane-4,4′-diisocyanate were slowly added at the temperature of approximately 55° C. After stirring for an additional 30 minutes at approximately 55° C., 6.8 parts of 1,4-butyleneglycol were slowly added, and the whole mixture was then heated to approximately 65° C. for approximately 30 minutes, then to approximately 75° C. for approximately 2 hours to complete the reaction. The resulting product was a blue viscous polyurethane solution having 35% solids content by weight.

### EXAMPLE 3

This example demonstrates the production of a colored synthetic leather in accordance with the invention. The yellow polyurethane prepolymer solution prepared in Example 1 was directly applied onto a commercially available silicone-treated mirror-surface release paper to form a film coating of the prepolymer having a thickness of approximately 0.15 mm. A commercially available “BASE substrate” having a thickness of approximately 1 mm (a non-woven fibrous sheet having a thickness of approximately 80 microns which has been impregnated/coated with a polyurethane elastomer) was then pressed/bonded onto this coating layer. The resulting assembly is then placed in an oven at approximately 120° C. for approximately 3 minutes. The assembly was removed from the oven, allowed to cool to room temperature, and the release paper was then peeled off of the assembly. The resulting yellow, synthetic leather article comprises the BASE substrate and a resin coating on the surface thereof, which contains an active hydrogen-terminated colorant conforming to structure (XVII). Furthermore, visual inspection of the release paper revealed no visible yellow color, which suggests that no appreciable amount of the yellow dye had migrated onto the release paper during the process.

### EXAMPLE 4

This example demonstrates the production of a colored synthetic leather in accordance with the invention. 1 part of the yellow polyurethane prepolymer prepared in Example 1 was mixed with 9 parts of a polyurethane pre-skin resin (UR-1390ND from Home Sun Industrial Co., Taiwan) in DMF/toluene/methyl ethyl ketone (MEK). The polyurethane pre-skin resin had a solids content of approximately 17%. The uniformly mixed polyurethane solution was then directly applied onto a commercially available silicone-treated mirror-surface release paper to form a film coating having a thickness of approximately 0.10 mm, and the release paper was then placed in an oven maintained at approximately 120° C. for approximately 1 minute to cure the resin. The coated paper was then removed from the oven and allowed to cool to room temperature. A 0.15 mm-thick coating of a polyurethane resin solution (SU13-550 from Stahl USA Inc. having 27% solids content) was then directly applied to the coated release paper. The resulting coated paper was then placed in an oven maintained at approximately 120° C. for approximately 2 minutes. The paper was then removed from the oven and cooled to room temperature. A 0.05 mm-thick layer of an adhesive resin solution (SU41-952 from Stahl USA Inc.) was applied to the coated paper. A “BASE substrate” (as described above) was then pressed/bonded onto the coated paper. The resulting assembly was placed in an oven maintained at approximately 120° C. for approximately 3 minutes. The assembly was then removed from the oven, allowed to cool to room temperature, and the release paper was removed. The resulting yellow, synthetic leather article comprises the BASE substrate and a resin coating on the surface thereof, which contains an active hydrogen-terminated colorant conforming to structure (XVII). Furthermore, visual inspection of the release paper revealed no visible yellow color, which suggests that no appreciable amount of the yellow dye had migrated onto the release paper during the process.

### EXAMPLE 5

This example demonstrates the production of a colored synthetic leather in accordance with the invention. The procedure of Example 3 was repeated using the blue polyurethane prepolymer prepared in Example 2 in place of the yellow polyurethane prepolymer. The resulting blue, synthetic leather article comprises the BASE substrate and a resin coating on the surface thereof, which contains an active hydrogen-terminated colorant conforming to structure (XXII). Furthermore, visual inspection of the release paper revealed no visible blue color, which suggests that no appreciable amount of the blue dye had migrated onto the release paper during the process.

### EXAMPLE 6

This example demonstrates the production of a colored synthetic leather in accordance with the invention. The procedure of Example 4 was repeated using the blue polyurethane prepolymer prepared in Example 2 in place of the yellow polyurethane prepolymer. The resulting blue, synthetic leather article comprises the BASE substrate and a resin coating on the surface thereof, which contains an active hydrogen-terminated colorant conforming to structure (XXII). Furthermore, visual inspection of the release paper revealed no visible blue color, which suggests that no appreciable amount of the blue dye had migrated onto the release paper during the process.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A leather article comprising:
(a) a substrate having at least one surface, the substrate being selected from the group consisting of fibrous substrates, natural leather substrates, and combinations thereof, and
(b) a coating on the surface of the substrate, the coating comprising a prepolymer or resin produced by the reaction of:
(i) an isocyanate,
(ii) at least one reactant selected from the group consisting of chain extenders, polyols, and combinations thereof, and
(iii) an active hydrogen-terminated colorant, the active hydrogen-terminated colorant being selected from the group of colorants conforming to structure (I) 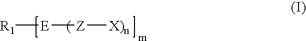
wherein R₁ or R₁-[E]ₘ is an organic chromophore, E is a linking moiety selected from the group consisting of nitrogen, oxygen, sulfur, a sulfite group, a sulfonamide group, and a carboxyl group, and n and m are independently selected from the group consisting of integers between 1 and 5;
wherein each Z is a divalent organic moiety independently selected from the group consisting of C₁-C₂₀ alkyl moieties, aryl moieties, and alkoxyl moieties;
wherein each X is an end group independently selected from the group consisting of hydrogen, a hydroxyl group, a sulfhydryl group, thiol groups, amine groups, alkyl groups, aryl groups, alkyl ester groups, aryl ester groups, organic sulfonate groups, organic sulfate groups, and amide groups; and
wherein at least one -Z-X constituent terminates in a group selected from the group consisting of a hydroxyl group, thiol groups, primary amine groups, secondary amine groups, primary amide groups, and secondary amide groups.

2. The article of claim 1, wherein the active hydrogen-terminated colorant conforms to structure (IV) 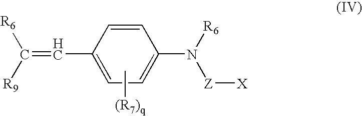
wherein R₆ is selected from the group consisting of hydrogen, alkyl groups, aryl groups, arylalkyl groups, alkylaryl groups, and active hydrogen-terminated constituents having the structure -Z-X;
wherein each R₇ is independently selected from the group consisting of hydrogen, halogen atoms, alkyl groups, alkoxy groups, nitrile groups, nitro groups, amide groups, and sulfonamide groups, and q is an integer between 0 and 4; and
wherein R₈ and R₉ are independently selected from the group consisting of hydrogen, halogen atoms, tertiary amino groups, imine groups, cyano groups, pyridinium groups, ester groups, amide groups, sulfate groups, sulfonate groups, sulfide groups, sulfoxide groups, phosphine groups, phosphinium groups, phosphate groups, nitrile groups, mercapto groups, nitro groups, sulfone groups, acyl groups, azo groups, alkyl groups, alkoxy groups, aryl groups, aryloxy groups, arylalkyl groups, arylalkoxy groups, alkylaryl groups, and alkylaryloxy groups.

4. The article of claim 2, wherein the active hydrogen-terminated colorant conforms to structure (V) 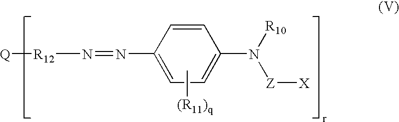
wherein R₁₀ is selected from the group consisting of hydrogen, alkyl groups, aryl groups, arylalkyl groups, alkylaryl groups, and active hydrogen-terminated constituents having the structure -Z-X;
wherein each R₁₁ is independently selected from the group consisting of hydrogen, halogen atoms, alkyl groups, alkoxy groups, nitrile groups, nitro groups, amide groups, and sulfonamide groups, and q is an integer between 0 and 4;
wherein R₁₂ is selected from the group consisting of aromatic groups and heteroatom-containing aromatic groups;
wherein Q is hydrogen or a linking group selected from the group consisting of oxygen, sulfur, a carbonyl group, a sulfonyl group, a 1,3-benzothiazole group, substituted 1,3-benzothiazole groups, C₁-C₈ alkyl groups, C₂-C₈ alkene groups, a p-phenylenediamine group, a m-hydroxybenzene group, and a m-di(C₁-C₄) alkoxybenzene group; and
wherein r is equal to 1 or 2.

5. The article of claim 2, wherein the active hydrogen-terminated colorant conforms to structure (VI) 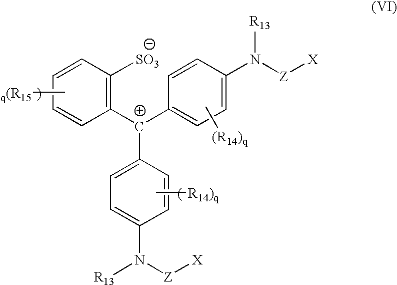
wherein R₁₃ is selected from the group consisting of hydrogen, alkyl groups, aryl groups, arylalkyl groups, alkylaryl groups, and active hydrogen-terminated constituents having the structure -Z-X;
wherein R₁₄ is selected from the group consisting of hydrogen, halogen atoms, alkyl groups, alkoxy groups, alkylamino groups, and arylamino groups;
wherein R₁₅ is selected from the group consisting of hydrogen, halogen atoms, alkyl groups, alkoxy groups, alkylamino groups, arylamino groups, cyano groups, nitro groups, amide groups, sulfite groups, and sulfonamide groups; and
wherein each q is an integer between 0 and 4.

6. The article of claim 2, wherein the active hydrogen-terminated colorant conforms to structure (VII) 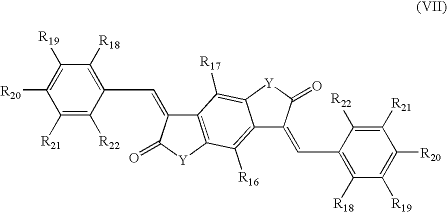
wherein Y is selected from the group consisting of oxygen, sulfur, and groups having the structure —NR₄₀, wherein R₄₀ is selected from the group consisting of hydrogen, alkyl groups, and aryl groups;
wherein R₁₆ and R₁₇ are independently selected from the group consisting of hydrogen, halogen atoms, a hydroxyl group, alkyl groups, alkenyl groups, and alkoxy groups;
wherein R₁₈, R₁₉, R₂₀, R₂₁, and R₂₂ are independently selected from the group consisting of hydrogen, halogen atoms, C₁-C₂₀ alkyl groups, C₁-C₂₀ alkylester groups, a hydroxyl group, thio groups, cyano groups, sulfonyl groups, sulfo groups, sulfato groups, aryl groups, nitro groups, carboxyl groups, C₁-C₂₀ alkoxy groups, C₁-C₂₀ alkylamino groups, acrylamino groups, C₁-C₂₀ alkylthio groups, C₁-C₂₀ alkylsulfonyl groups, C₁-C₂₀ alkylphenyl groups, phosphonyl groups, C₁-C₂₀ alkylphosphonyl groups, C₁-C₂₀ alkoxycarbonyl groups, phenylthio groups, and active hydrogen-terminated constituents having the structure -E-(Z-X)ₙ;
wherein at least one of R₁₈, R₁₉, R₂₀, R₂₁, and R₂₂ is an active hydrogen-terminated constituent having the structure -E-(Z-X)ₙ.

7. The article of claim 2, wherein the active hydrogen-terminated colorant conforms to structure (VIII) 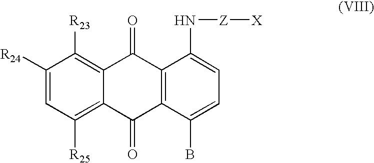
wherein R₂₃ is selected from the group consisting of hydrogen, halogen atoms, a hydroxyl group, amine groups, nitro groups, and acetamide groups;
wherein R₂₄ and R₂₅ are independently selected from the group consisting of hydrogen and a hydroxyl group; and
wherein B is selected from the group consisting of groups conforming to structure (XV) and structure (XVI) 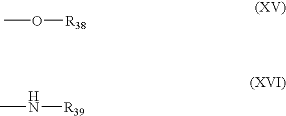
wherein R₃₈ is selected from the group consisting of hydrogen, C₁-C₁₈ alkyl groups, and aryl groups; and
wherein R₃₉ is selected from the group consisting of aryl groups and active hydrogen-terminated constituents having the structure -Z-X.

8. The article of claim 1, wherein the resin and the active hydrogen-terminated colorant are copolymerized.

9. The article of claim 1, wherein the substrate is a textile material selected from the group consisting of woven textiles, knit textiles, and non-wovens.

10. A leather article comprising:
(a) a substrate having at least one surface, wherein the substrate is a nonwoven material comprising a plurality of fibers and a plurality of interstitial spaces between the fibers, and
(b) a prepolymer or resin provided in at least a portion of the interstitial spaces, the prepolymer or resin being produced by the reaction of:
(i) an isocyanate,
(ii) at least one reactant selected from the group consisting of chain extenders, polyols, and combinations thereof, and
(iii) an active hydrogen-terminated colorant, the active hydrogen-terminated colorant being selected from the group of colorants conforming to structure (I) 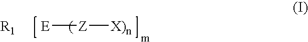
wherein R₁ or R₁-[E]ₘ is an organic chromophore, E is a linking moiety selected from the group consisting of nitrogen, oxygen, sulfur, a sulfite group, a sulfonamide group, and a carboxyl group, and n and m are independently selected from the group consisting of integers between 1 and 5;
wherein each Z is a divalent organic moiety independently selected from the group consisting of C₁-C₂₀ alkyl moieties, aryl moieties, and alkoxyl moieties;
wherein each X is an end group independently selected from the group consisting of hydrogen, a hydroxyl group, a sulfhydryl group, thiol groups, amine groups, alkyl groups, aryl groups, alkyl ester groups, aryl ester groups, organic sulfonate groups, organic sulfate groups, and amide groups; and
wherein at least one -Z-X constituent terminates in a group selected from the group consisting of a hydroxyl group, thiol groups, primary amine groups, secondary amine groups, primary amide groups, and secondary amide groups.

11. A method for producing a leather article, the method comprising the steps of:
(a) providing a prepolymer or resin produced by the reaction of (i) an isocyanate, (ii) at least one reactant selected from the group consisting of chain extenders, polyols, and combinations thereof, and (iii) an active hydrogen-terminated colorant, the active hydrogen-terminated being selected from the group of colorants conforming to structure (I) 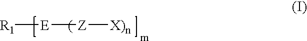
wherein R₁ or R₁-[E]ₘ is an organic chromophore, E is a linking moiety selected from the group consisting of nitrogen, oxygen, sulfur, a sulfite group, a sulfonamide group, and a carboxyl group, and n and m are independently selected from the group consisting of integers between 1 and 5;
wherein each Z is a divalent organic moiety independently selected from the group consisting of C₁-C₂₀ alkyl moieties, aryl moieties, and alkoxyl moieties;
wherein each X is an end group independently selected from the group consisting of hydrogen, a hydroxyl group, a sulfhydryl group, thiol groups, amine groups, alkyl groups, aryl groups, alkyl ester groups, aryl ester groups, organic sulfonate groups, organic sulfate groups, and amide groups; and
wherein at least one -Z-X constituent terminates in a group selected from the group consisting of a hydroxyl group, thiol groups, primary amine groups, secondary amine groups, primary amide groups, and secondary amide groups;
(b) applying the prepolymer or resin onto at least a portion of a transfer substrate to form a film coating of the prepolymer or resin;
(c) applying a backing substrate onto the film coating of the prepolymer or resin produced in step (b);
(d) heating the assembled backing substrate, film coating, and transfer substrate to bond the backing substrate to the film coating of the prepolymer or resin, and
(e) removing the transfer substrate to yield a leather article comprising the backing substrate and a coating on a surface thereof, the coating comprising a prepolymer or resin produced by the reaction of (i) the isocyanate, (ii) the at least one reactant selected from the group consisting of chain extenders, polyols, and combinations thereof, and (iii) the active hydrogen-terminated colorant.

12. The method of claim 11, wherein the backing substrate is selected from the group consisting of fibrous substrates, natural leather substrates, and combinations thereof.

13. The method of claim 11, wherein the backing substrate is a textile material selected from the group consisting of woven textiles, knit textiles, and non-wovens.

14. The method of claim 11, wherein the active hydrogen-terminated colorant conforms to structure (XVII)

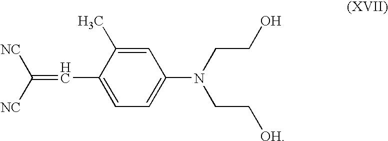

15. The method of claim 11, wherein the active hydrogen-terminated colorant conforms to structure (XVIII)

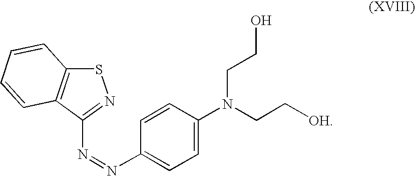

16. The method of claim 11, wherein the active hydrogen-terminated colorant conforms to structure (XXII) 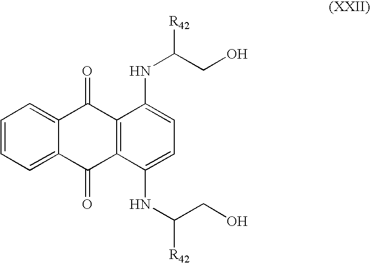
wherein R₄₂ is selected from the group consisting of hydrogen, methyl groups, and ethyl groups.

17. A method for producing a leather article, the method comprising the steps of:
(a) providing a prepolymer or resin produced by the reaction of (i) an isocyanate, (ii) at least one reactant selected from the group consisting of chain extenders, polyols, and combinations thereof, and (iii) an active hydrogen-terminated colorant, the active hydrogen-terminated being selected from the group of colorants conforming to structure (I) 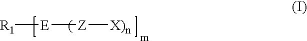
wherein R₁ or R₁-[E]ₘ is an organic chromophore, E is a linking moiety selected from the group consisting of nitrogen, oxygen, sulfur, a sulfite group, a sulfonamide group, and a carboxyl group, and n and m are independently selected from the group consisting of integers between 1 and 5;
wherein each Z is a divalent organic moiety independently selected from the group consisting of C₁-C₂₀ alkyl moieties, aryl moieties, and alkoxyl moieties;
wherein each X is an end group independently selected from the group consisting of hydrogen, a hydroxyl group, a sulfhydryl group, thiol groups, amine groups, alkyl groups, aryl groups, alkyl ester groups, aryl ester groups, organic sulfonate groups, organic sulfate groups, and amide groups; and
wherein at least one -Z-X constituent terminates in a group selected from the group consisting of a hydroxyl group, thiol groups, primary amine groups, secondary amine groups, primary amide groups, and secondary amide groups;
(b) providing a backing substrate,
(c) applying the prepolymer or resin onto at least a portion of a surface of the backing substrate,
(d) heating the coated backing substrate produced in step (c) to produce a coating on the surface of the backing substrate, thereby yielding a leather article comprising the backing substrate and a coating on a surface thereof, the coating comprising a prepolymer or resin produced by the reaction of (i) the isocyanate, (ii) the at least one reactant selected from the group consisting of chain extenders, polyols, and combinations thereof, and (iii) the active hydrogen-terminated colorant.

18. The method of claim 17, wherein the backing substrate is a textile material selected from the group consisting of woven textiles, knit textiles, and non-wovens.

19. The method of claim 17, wherein the active hydrogen-terminated colorant conforms to structure (XVII)

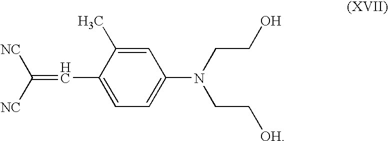

20. The method of claim 17, wherein the active hydrogen-terminated colorant conforms to structure (XVIII)

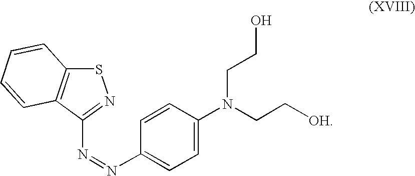

21. The method of claim 17, wherein the active hydrogen-terminated colorant conforms to structure (XXII) 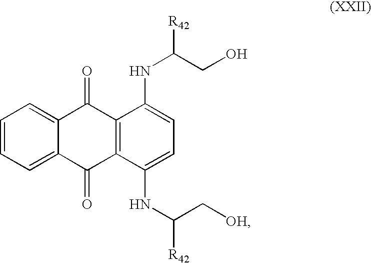
wherein R₄₂ is selected from the group consisting of hydrogen, methyl groups, and ethyl groups.
